(19) United States
(12) Patent Application Publication
(10) Pub. No.: US 2011/0257985 A1
(43) Pub. Date: Oct. 20, 2011

(54) Method and System for Facial Recognition Applications including Avatar Support

(76) Inventor: Boris Goldstein, San Franscisco, CA (US)

(21) Appl. No.: 12/760,267

(22) Filed: Apr. 14, 2010

(51) Int. Cl. G06F 17/30; G06T 15/00; G06Q 30/00; G06K 9/62

(52) U.S. Cl. 705/1.1; 382/118; 345/419; 707/812; 707/E17.044

(57) ABSTRACT

Described herein are systems and methods for analyzing captured facial data with stored weights and dynamic profile in coordination with predefined rules and policy management. One embodiment of the disclosure of this application is related to systems and methods comprising acquisition of facial recognition data (“FRD”) related to a customer, processing the FRD to generate a facial data identification (“FDI”), and analysis of a database including a plurality of customer profiles to match the FDI with a stored FRD corresponding to a customer, each customer profile including one of customer-specific keywords and customer-specific content. According to this exemplary systems and methods, when the FDI is unmatched, a new customer profile may be created including the FRD and the new customer profile may be matched with a commercial application. Furthermore, when the FDI is matched with an existing customer profile, the existing customer profile may be updated and a service associated with the one of customer-specific keywords and customer-specific content stored in the matched customer profile may be performed. The exemplary systems and methods may further include creation of an avatar based on the existing customer profile for communication applications, wherein the avatar is used in one of a pay-per-click application, a pay-per-action application, and a pay-per-lead application.

### BACKGROUND

The web is growing much faster than any present-technology search engine can possibly index. Many web pages are updated frequently, which forces the search engine to revisit them periodically. The queries one can make are currently limited to searching for key words, which may result in many false positives.

Dynamically generated sites may be slow or difficult to index, and/or may result in excessive results from a single site. In addition, many dynamically generated sites are not indexable by search engines. This phenomenon is known as the invisible web. Furthermore, some search engines do not order the results based on relevance, but based on other factors, such as according to how much money the sites have paid them. Some sites use tricks to manipulate the search engine to display them as the first result returned for some keywords. Accordingly, this can lead to some search results being polluted, with more relevant links being pushed down in the result list.

Web search engines work by storing information about a large number of web pages, which the engines retrieve from the Internet, itself. These pages are retrieved by an automated web browser (e.g., a meta-crawler, a web crawler or a spider), which follows every link it sees. The contents of each page are then analyzed to determine how it should be indexed. For example, words are extracted from the titles, headings, or special fields called meta tags. Data about web pages is stored in an index database for use in later queries.

A typical meta-crawler use weight of keywords and phrases in order to generate more relevant search. However, the method of searching performed by a meta-crawler is based primarily on an Internet profile or cookies stored on the user's computer. Therefore, these profiles and cookies are specific to the device used to access the Internet, namely the computer, and not specific to the user of the device. Thus, this method of searching does not recognize a profile attached to the user of the computer.

### SUMMARY OF THE INVENTION

Described herein are systems and methods for analyzing captured facial data with stored weights and dynamic customer profile in coordination with predefined rules and policy management. One embodiment of the disclosure of this application is related to method comprising acquiring facial recognition data (“FRD”) related to a customer, processing the FRD to generate a facial data identification (“FDI”), and analyzing a database including a plurality of customer profiles to match the FDI with a stored FRD corresponding to a customer, each customer profile including one of customer-specific keywords and customer-specific content. According to this exemplary method, when the FDI is unmatched, the method creates a new customer profile including the FRD and matching the new customer profile with a commercial application. Furthermore, when the FDI is matched with an existing customer profile, the method updates the existing customer profile and performing a service associated with the one of customer-specific keywords and customer-specific content stored in the matched customer profile.

A further embodiment of the disclosure of this application is related to a system including a facial recognition arrangement acquiring facial recognition data (“FRD”) related to a customer and a server processing the FRD to generate a facial data identification (“FDI”). The exemplary server analyzes a database including a plurality of customer profiles to match the FDI with a stored FRD corresponding to a customer, each customer profile including one of customer-specific keywords and customer-specific content. According to this exemplary method, when the FDI is unmatched, the server creates a new customer profile including the FRD and matches the new customer profile with a commercial application. Furthermore, when the FDI is matched with an existing customer profile, the server updates the existing customer profile and performs a service associated with the one of customer-specific keywords and customer-specific content stored in the matched customer profile.

A further embodiment of the disclosure of this application is related to a computer readable storage medium including a set of instructions that are executable by a processor, the set of instructions being operable to acquire facial recognition data (“FRD”) related to a customer, process the FRD to generate a facial data identification (“FDI”), and analyze a database including a plurality of customer profiles to match the FDI with a stored FRD corresponding to a customer, each customer profile including one of customer-specific keywords and customer-specific content. When the FDI is unmatched, the set of instructions may be further operable to create a new customer profile including the FRD and match the new customer profile with a commercial application. When the FDI is matched with an existing customer profile, the set of instructions may be further operable to update the existing customer profile and perform a service associated with the one of customer-specific keywords and customer-specific content stored in the matched customer profile.

### BRIEF DESCRIPTION OF THE DRAWINGS

FIG. 1 shows an exemplary system for capturing, recognizing, and analyzing facial data according to the exemplary embodiments of the present invention.

FIG. 2 shows an exemplary database arrangement for storing facial data with associated dynamic customer profile information according to the exemplary embodiments of the present invention.

FIG. 3 shows an exemplary method for capturing, recognizing, and analyzing facial data according to the exemplary embodiments of the present invention.

FIG. 4 shows an exemplary system for implementing a facial recognition arrangement at a point-of-sale location according to the exemplary embodiments of the present invention.

### DETAILED DESCRIPTION

The exemplary embodiments of the application may be further understood with reference to the following description and the related appended drawings, wherein like elements are provided with the same reference numerals. The exemplary embodiments of the application are related to systems and methods for using facial capture data at points of capture and transmission to a facial recognition database. Specifically, the exemplary embodiments are related to systems and methods for analyzing captured facial data with stored weights and dynamic customer profile in coordination with predefined rules and policy management. For instance, these rules and policy management may include related advertisement and marketing messages based on an identified face and a matched profile.

As will be described in greater details below, the exemplary embodiments of the present invention may provide for acquiring of facial data from numerous individuals, building dynamic customer profiles for each of these individuals to include the facial data and “keywords,” and the applying these dynamic customer profiles towards customizable services targeted directly towards this individual based on the keywords of each individual. The keywords built into an individual's dynamic profile may include any number of products, services, transactions, locations, inquiries, habits, preferences, and/or historical uses associated with the individual, as well as with any other activities associated with the individual.

According to the present invention, the exemplary embodiments described herein may include a fully customizable arrangement having the ability to integrate with a variety of different system and applications, such as for example, a central monitoring stations, security management systems, surveillance systems, point of sales (“POS”) systems, automated teller machines (“ATMs”), access control systems, alarm systems, etc. Accordingly, the exemplary embodiments may be implemented onto existing systems in order to improve the security aspect of management, as well as improving the productivity and efficiency of using the same surveillance equipment (e.g., cameras, detectors, etc.). The exemplary embodiments may provide affordable, plug-in compatible functional upgrades to a large base of pre-existing analog-based CCTV video surveillance systems. In addition, the exemplary embodiments may provide affordable original equipment manufacturers (“OEM”) components to new analog-based and IP-network based video surveillance systems. As will be described below, these new systems may include biometric detectors, facial recognition arrangements, license plate recognition technologies, etc. Furthermore, the exemplary embodiments of the present invention may also provide a market proven solution through integration with POS (e.g., cash registers, credit card readers, etc.), ATM systems, access control systems, fire alarm systems, etc.

A facial recognition system, according to the embodiments described here in, may describe a computer application for automatically identifying or verifying a person from a digital image or a video frame from a video source. One of the ways in which this is accomplished in to comparing selected facial features from the image with components in a facial database. Some facial recognition algorithms identify faces by extracting landmarks, or features, from an image of the subject's face. It is known that a typical “metacrowler” uses weigh of keywords and phrases to generate more relevant search, it is also known that facial recognition uses an internal vector database and relevant faces to match faces in database and achieve maximum results accuracy in facial recognition. However, the first method of searches is limited to stored Internet profiles or cookies and/or direct matching of searches. Accordingly, these typical methods cannot be used for recognizing profiling attached to specific face in a database.

According to the exemplary systems and methods described herein, an algorithm may analyze the relative position, size, and/or shape of the subject's eyes, nose, cheekbones, jaw, etc. These features are then used to search for other images with matching features. Other algorithms normalize a gallery of face images and then compress the face data, only saving the data in the image that is useful for face detection. A probe image is then compared with the face data. One of the earliest, successful systems is based on template matching techniques applied to a set of salient facial features, providing a sort of compressed face representation. Recognition algorithms can be divided into two main approaches. The first approach being a geometric method that may look at distinguishing features of an image. The second approach being a statistical photometric method that that may distill an image into values and comparing the values with templates to eliminate variances.

According to the exemplary embodiments of the present invention, each face captured from an individual may be “vectorized” (e.g., 3-dimensionally, 2-dimensionally) and stored into a unique profile for this individual. This profile may include addition personal information related to the individual, including, but not limited to, a name, a identification number (e.g., Social Security number, employment identification number, etc.), as well as biometric data such as voice, fingerprint, palm print, retina scan, etc. This profile, along with any further identifying information, may be stored within a facial database of unique profile, such as a “gallery of faces.”

As will be described in greater detail below, once a customer profile has been generated for an individual, the profile may coordinate with any number of external databases and integrated systems. For instance, each unique profile within the facial database may include supplemental information from external retail/consumer databases (e.g., client lists, VIP lists, customer preference record, black lists, etc.), from external banking/financial databases (e.g., sale transaction records, credit card accounts, ATM records, etc.), from external government databases (e.g., watch lists, sexual offender list, parole records, etc.), transportation databases (e.g., traffic monitoring systems, license plate recognition systems, etc.), education databases, industrial databases, etc. Accordingly, any and/or all of these external databases may be integrated into the exemplary facial database. Specifically, in addition to the facial data and biometric data captured for an individual, the individual's profile may be expanded to include information from these external databases. Certain static information, such as identification data, may be retrieved upon the creation of the individual's profile, while other dynamic information, such as transactional data, may be continuously added and adjusted to the individual's profile.

Throughout the creation and adjustments of the individual's profile, the exemplary system may learn to associate the individual with searchable “keywords” (e.g., targeted words, phrases, and/or content associated with that specific individual). For instances, these keywords may include information such as service preferences of the individual, consumer products targeted by or for the individual, one or more of the individual's characteristics, a previous inquiry made by the individual, retail outlets, locations and destinations, etc.

Therefore, the exemplary systems and methods may increase the accuracy of searches though the use of facial recognition. Specifically, the systems and methods may utilize a neuro-net auto-educational algorithms to improve search quality for different faces with attached customer profiles and policy management to improve quality of advertisement and marketing based on face capture and facial recognition with policy management using targeted words, keywords, phrases and content. In other words, the exemplary system and method may improve overall efficiency in searches using facial recognition with attached profiling using keywords, phrases, content search, and increase accuracy of advertisement and marketing using facial recognition. Furthermore, these systems and methods may increase the accuracy of marketing and advertisement by using face as targeted venue for pay per lead, pay per call, pay per question model.

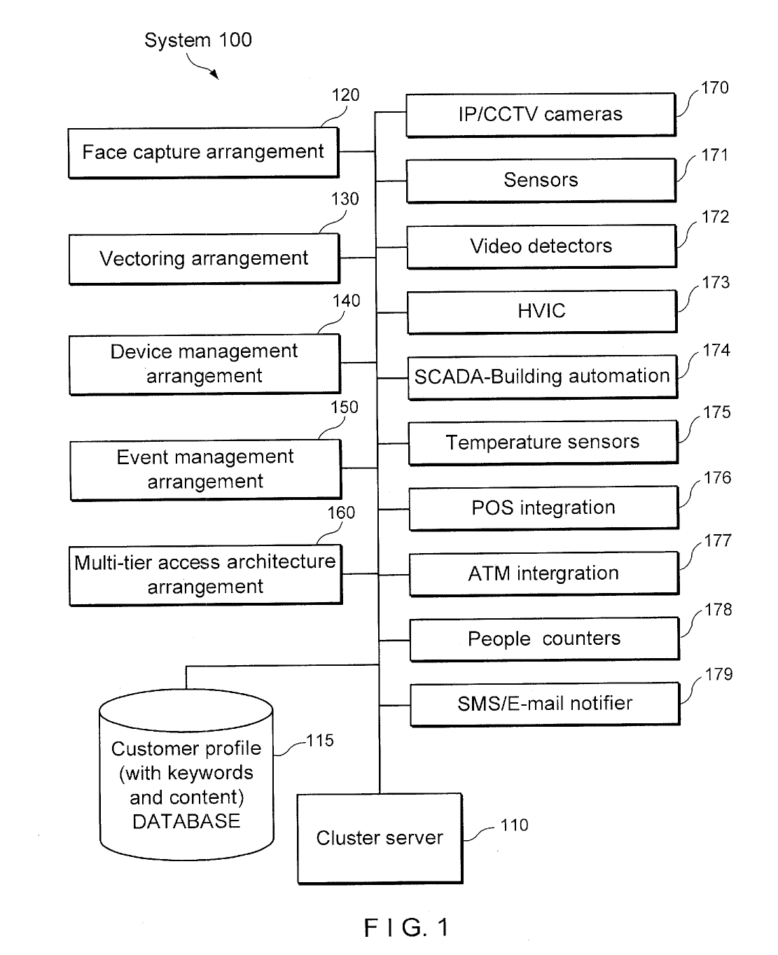

FIG. 1 shows an exemplary system 100 for capturing, recognizing, and analyzing facial data according to the exemplary embodiments of the present invention. The system may include a server 110, a customer profile with keywords and content database 115 (e.g., a gallery of faces, a facial database, a database of profiles, etc.), a face capturing arrangement 120, a vectoring arrangement 130 (e.g., a digital processing arrangement), a device management arrangement 140, an event management arrangement 150, and a multi-tier access architecture arrangement 160. The system 100 may further include devices such as, but is not limited to, IP/CCTV Cameras 170, sensors 171, video detectors 172, HVIC components 173, SCADA building automation components 174, temperature sensors 175, POS integration components 176, ATM integration components 177, people/passenger counting components 178, SMS and/or email notification systems 179, etc.

The face capturing arrangement 120 may include, but is not limited to, a facial/voice capturing component, cameras, voice recorders, etc. Other components available (not shown) may include license plate recognition components, transit processing systems, cargo characteristic recognition systems, etc. It should be noted that the exemplary system 100 is not limited to a particular set of included components, and may include any number of components, either more or less than those illustrated in FIG. 1. Furthermore, each of these components of the system 100 may reside on a single component, or alternatively, on any number of components within the system 100.

According to the exemplary embodiments of the present invention, the system 100 may allow for increasing accuracy of searches using a facial database 115. Specifically, the system 100 of the system 100 may improve quality of marketing and advertisement using facial data stored in the database 115 along with specific additional data to the face (e.g., individual). This additional data may include, but is not limited to keywords, phrases, content, etc. Accordingly, the system 100 may utilize exemplary neuro-net algorithms for searches, as well as facial comparisons having weighted keyword from other search engines.

The exemplary database 115 may allow for the storage of customer profiles and related information. In addition, the database 115 may store backup archives containing large volumes of data, export specified images, export, printing and transfer of images, support of external devices, registration of all events (e.g., movements, changes of background, etc.), flexible choice of recording modes, such as registration of faces stored at the database, sorting and search of events by date, time and type, and simultaneous playback, recording and search of backup data, etc.

The usefulness of a search engine depends on the relevance of the results it gives back. While there may be millions of Web pages that include a particular word or phrase, some pages may be more relevant, popular, and/or authoritative than others. Typical search engines employ methods to rank the results to provide the “best” results first. How a search engine decides which pages are the best matches, and in what order the results should be shown in, will vary widely from one engine to another. The methods also change over time as Internet usage changes and new techniques evolve. Furthermore, typical Web search engines are commercial ventures supported by advertising revenue and, as a result, some employ the controversial practice of allowing advertisers to pay money to have their listings ranked higher in search results.

The operations of the exemplary system 100 and the vectoring arrangement 130 may use scalable network architecture for facial data capture, face identification and recognition, matching facial data with face associated data flow and customer profile and keyword, and then clustering to an advertiser's keyword matching engine for follow up actions like pay per click, pay per call, pay per action transactions.

Ultimately, the capabilities of the system 100 and its components are limitless. The operations of the system 100 may be fully scalable to match any desired solution for the using facial data capture and recognition. As will be described in greater detail below, the system 100 may integrate the facial data with data from any number of systems. As noted above, these systems may include, for example, ATMs and POS systems, access control systems, policy management and event driven engines, etc. Furthermore, the customer profile matching described for the systems and methods herein may be used for marketing and distributed database. Accordingly, this may allow for the formation of a clustering neuro-net search engine which can be used for targeting advertisement (e.g., content, keywords, multiple keywords and phrases, etc.) using facial images as target for any advertiser follow action such as pay per click, pay per action, pay per question, etc.

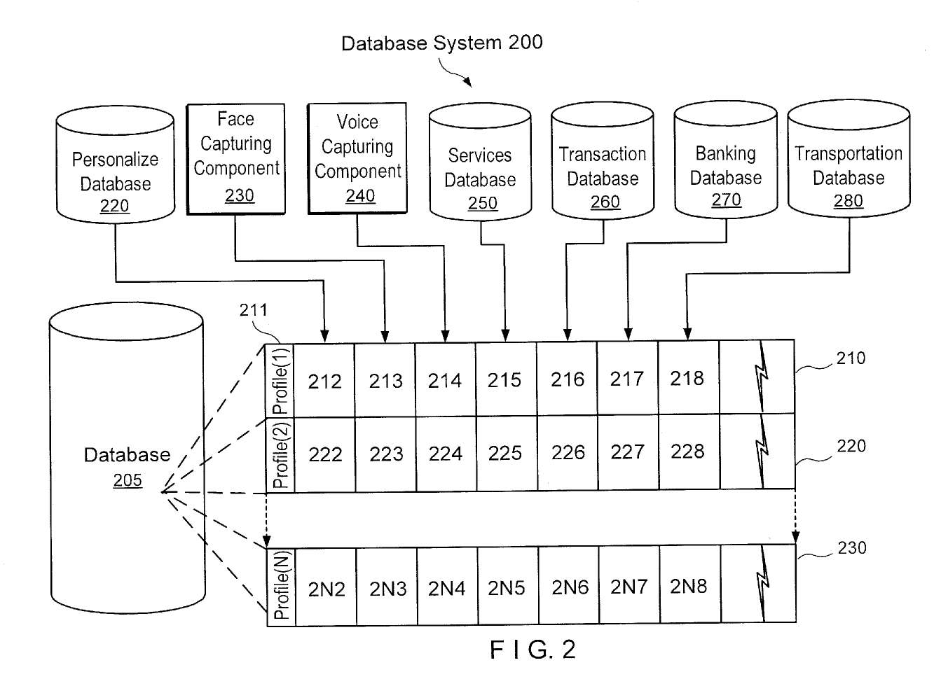

FIG. 2 shows an exemplary database system 200 for storing facial data with associated dynamic customer profiles information according to the exemplary embodiments of the present invention. The database system 200 may include an exemplary profile database 205, wherein any number of unique individual profiles (e.g., Profile(1) 210, Profile(2) 220, Profile(N) 230, etc.) may be generated, adjusted, and stored. As noted above, each of the stored profiles 210-230 may receive information from numerous sources, including, but not limited to, captured facial data, captured voice data, personal identification data, associated keyword information, transactional data, as well as any further information from external databases. Therefore, each of the profiles 210-230 may allow for facial/voice data to be dynamically coordinated with any detectable actions performed by the individual. Each of the profiles 210-230 may be built to evolve as further information about the individual is gather.

For instance, Profile(1) 210 may be a unique profile for an individual named John Smith. The Profile(1) 210 may include a header 211 that labels the profile as Profile(1) to the database 205 and any other systems accessing the database 205. The Profile(1) 210 may include personal identification information 212, such as a name “John Smith”, a social security number, an employment number, etc. This personal identification information 212 may be retrieved from one or more personalized databases 220. The Profile(1) 210 may include vectorized facial data 213 of the individual. The facial data 213 may have been previously captured by a facial capturing component 230 and stored within the database 205. Upon associating the stored facial data 213 with the individual John Smith, the captured facial data 213 may be placed within the Profile(1) 210. The Profile(1) 210 may further include voice data 214 of the individual. The voice data 214 may have been previously captured by a voice capturing component 240 and stored within the database 205. Upon associating the stored voice data 214 with the individual John Smith, the captured voice data 214 may be placed within the Profile(1) 210. Each of the above-mentioned blocks of data 211-214 may be consider static data of the individual John Smith, and thus may serve as a foundation for the Profile(1) 210 of John Smith.

In order for the Profile(1) 210 to dynamically adjust to the characteristics and preferences of John Smith, the database 205 may be integrated with numerous external systems and databases. Each of these external systems and databases may provide the Profile(1) 210 with additional data blocks associated with John Smith. Specifically, each time in which John Smith is identified by a system (e.g., via facial recognition, social security number usage, etc.), further data associated with John Smith may be collected into the database 205 and added to the dynamic customer profile 210 of John Smith. For instance, the Profile(1) 210 may receive additional information about John Smith from external consumer services databases 215 (e.g., client lists, VIP lists, customer preference record, black lists, etc.). The Profile(1) 210 may receive information from external retail transaction databases 216 (e.g., sale transaction records, products/services purchased, store locations, retail inquires, etc.). The Profile(1) 210 may receive information from external banking/financial databases 217 (e.g., credit card accounts, banking information, ATM usage records, etc.). The Profile(1) 210 may receive information from external government databases 218 (e.g., watch lists, sexual offender list, parole records, etc.). The Profile(1) 210 may receive information from transportation databases 219 (e.g., traffic monitoring systems, license plate recognition systems, etc.), etc.

Accordingly, for each instance wherein John Smith is identified, keywords in the form of targeted words, phrases, content, etc. may be added to and/or adjusted within the individual's profile 210. As an example, the use of a credit card of John Smith may be detected within a retail outlet. The transactional database 216 may provide the database 205 with information pertaining to any actions performed by John Smith, such as the location of the store, the purchase of an item, any inquiries made to a specific product, etc. As a further example, the facial data of John Smith may be detected in a transportation hub, such as a train station or airport. The transportation databases 219 may provide the database 205 with information pertaining to any actions performed by John Smith, such as the traveling habits of John Smith.

As this data is collected by the database 205 through various sources, the dynamic customer profile of John Smith, Profile(1) 210, may be modified accordingly. In reference to the examples used above, retail keywords may be collected such as “men's sweater”, “Macy's”, “New York, NY”, etc. Furthermore, transportation keywords may be collected such as “JFK airport”, etc. The inclusion of these keywords associated with the customer profile of John Smith may allow for greatly improved accuracy in targeted marketing and advertising. For instance, based on John Smith's updated customer profile, John Smith may receive notifications (e.g., SMS message, email, etc.) regarding a future sale at Macy's, and notifications regarding a new limo/car service or discounts on taxis servicing JFK airport. Thus, through the use of the database 205 of system 200, profiles 210-230 may be generated and maintained for numerous individuals based on a combination of identifying the individual and associating an action with the individual. The greater amount of actions associated with the individual will allow for a more detailed and customized profile of the individual based on products, services, transactions, inquiries, locations, habits, preferences, and/or historical uses associated with the individual, as well as with any other activities associated with the individual.

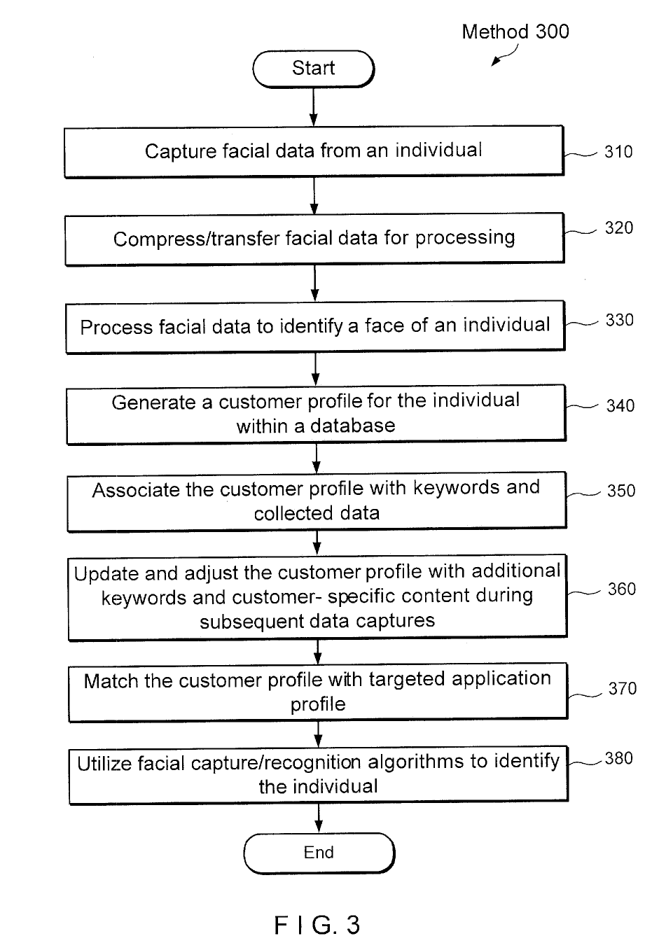

FIG. 3 shows an exemplary method 300 for capturing, recognizing, and analyzing facial data according to the exemplary embodiments of the present invention. The method 300 will be discussed with reference to the face capture system 110 and the server 110 of the system 100 of FIG. 1. It should be noted that method 300 is merely an exemplary embodiment of the steps and processes performed by the system 100. Accordingly, any number of steps within the method 300 may be repeated or omitted or performed in any sequence. In other words, the methods performable by the system 100 are not limited to the number steps illustrated in FIG. 3, nor the order/arrangement of the steps illustrated in FIG. 3. Furthermore, it should be noted that the step described below may be stored on a computer readable storage medium, wherein the steps (or set of instructions) may be executable by a processor. For example, the steps may be executable via a single web interface available to a user.

Beginning with step 310, the face capture system 110 may capture the facial data from an individual. For instance, facial data capture and face identification may be performed within a frame of video streaming. Facial capture software, according to the exemplary embodiments, may identify a human body spotted by camera as well as a position on head in order to capture optimal face images. Then, the face may be “blocked” in a focus while the face capture system 110 extracts the facial data from the image.

Using the exemplary facial capture software, the face capture system 110 is capable of seeing a full gallery of faces passing through entry points, entrance in the building, bank, offices, etc. The gallery faces may also very effective for networked systems, where there are multiple cameras, or even multiple locations. Accordingly, the face capture system 110 may be installed onto local cameras, capture faces, and be utilized within a proprietary system or third party facial recognition system.

In step 320, the face capture system 110 may compress the facial data and transfer the compressed facial data to the vectoring arrangement 130. For instance, delta wavelet compression may be created from the captured facial data, wherein this delta may then be transferred through network (e.g., system 100) to the vectoring arrangement 130. The system 100 may utilize a secured channel to transmit data, such as a public network and the TCP/IP protocol.

Wavelet frame compression is based on generating the video ordering. An exemplary wavelet codec (e.g., Motion Wavelet codec) may process changes by comparing each next frame to prior or some reference one. Such method makes Motion Wavelet different from JPEG and Wavelet algorithms, which use single frame compression, and thus neglect fact that video stream coming from the cameras is a kind of ordering. This is one of the benefits of Motion Wavelet compression. In comparison with the JPEG and Wavelet algorithms frame rate may be 5-10 times lesser. However, the quality may depend upon background, moving objects, and other parameters.

Using facial Motion Wavelet compression may increase number of faces processed through the system 100. In addition, it will allow for the use of lower bandwidth capacity to transmit captured faces through a network or wirelessly. This will be helpful in greatly decreasing the average frame rate in the video stream. Furthermore, this may enables the system 100 to economize on sizes of video archive, network traffic and network channel width. Thus, Motion Wavelet may adapt to channel capacity when transmitting faces through network.

It should be noted that the size of face captures may be only around 3 Kb to 5 Kb. Therefore, bandwidth may be not an issue, as even smart phones and PDAs will be able to receive captured facial data. Furthermore, a substantial amount of storage may be conserved with storing only faces in the system 100. Delta wavelet face compression will be discussed in further details below.

In step 330, the vectoring arrangement 130 may process facial data and identify a face from the facial data using facial recognition software. Recognition may take less than a second, depending on number of faces in database and bandwidth between local points for entry. It should be noted that the system may perform accurate recognition of a user with or with facial hair (e.g., a moustache or beard). For instance, if a person's face is recorded with no beard or no moustache, the face access control may record everyday changes of the person in order to continue recognition of this person.

In step 340, the vectoring arrangement 130 may generate a customer profile from the identified face and the processed facial data, the customer residing in a profile database 115. For instance, the vectoring arrangement 130 may create a customer profile including an individual's name, address, job title, employee number, facial data, etc.

In step 350, the vectoring arrangement 130 may associate the customer profile with keywords and dynamic data. For instance, the vectoring arrangement 130 may create a “dynamic” customer profile including further user information associated with face data. This further data may include keyword data, as well customer-specific data, such as credit/debit card data from POS, credit/debit card data from an ATM, security access granted to specific face, personal preferences (e.g., temperature, lighting, etc.) required by specific face within a specific location, etc.

In step 360, using profile database 115 with the identified face, the vectoring arrangement 130 may update and/or adjust the dynamic customer profile with specific keywords from a data capture. For example, the vectoring arrangement 130 may receive information such as “dog food bought from POS in retail location associated with specific face”. This information may be incorporate with the dynamic customer profile of that customer. The vectoring arrangement 130 may then use a neuro-net algorithm for clustering analysis of faces with keywords and associated dynamic data profiling and faces identifications matched with dynamic customer profile.

In step 370, the vectoring arrangement 130 may match the dynamic customer profile with one or more application profiles. For instance, an application profile, such as a matching advertisers profile (e.g., pay per click, pay per question, pay per lead), may be matched with a face and associated dynamic customer profile having specific keyword (e.g., keywords).

In step 380, the vectoring arrangement 130 may utilize a face capture and recognition ranking algorithms in order to keep face search result integrity. Furthermore, these ranking algorithms may allow for integrated data flow to be associated with a specific face and the corresponding dynamic customer profile. Thereby allow for further matching of advertisers demand on keywords for further action (e.g., pay per lead, pay per click, pay per question, etc.) with associated face, data profile and keywords.

To summarize, the exemplary method 300 may include acquiring facial recognition data (“FRD”) related to a customer, processing the FRD to generate a facial data identification (“FDI”), and analyzing a database including a plurality of customer profiles to match the FDI with a stored FRD corresponding to a customer, each customer profile including one of customer-specific keywords and customer-specific content. For instance, the FRD may be acquired from a facial recognition arrangement. In addition, the processing the FRD may include vectoring the facial data, compressing the facial data, and transferring the compressed facial data to a processing unit.

According to the exemplary method 300, when the FDI is unmatched, the method 300 may create a new customer profile including the FRD and may match the new customer profile with a commercial application. Furthermore, when the FDI is matched with an existing customer profile, the method 300 may update the existing customer profile and may perform a service associated with the one of customer-specific keywords and customer-specific content stored in the matched customer profile. In addition, when the FDI is unmatched, the method 300 may store one of new customer-specific keywords and new customer-specific content in the new customer profile, and may also store the new customer profile in the database.

According to the exemplary embodiments described herein, the commercial application may be based on integrated information received from databases such as a services database, a transaction database, a banking database, a transportation database, etc. Furthermore, according to the exemplary embodiments described herein, the systems and methods may include the creation of an avatar based on the existing customer profile for communication applications. For instances, the avatar may be used in any number of applications, such as, for example, a pay-per-click application, a pay-per-action application, a pay-per-lead application, etc.

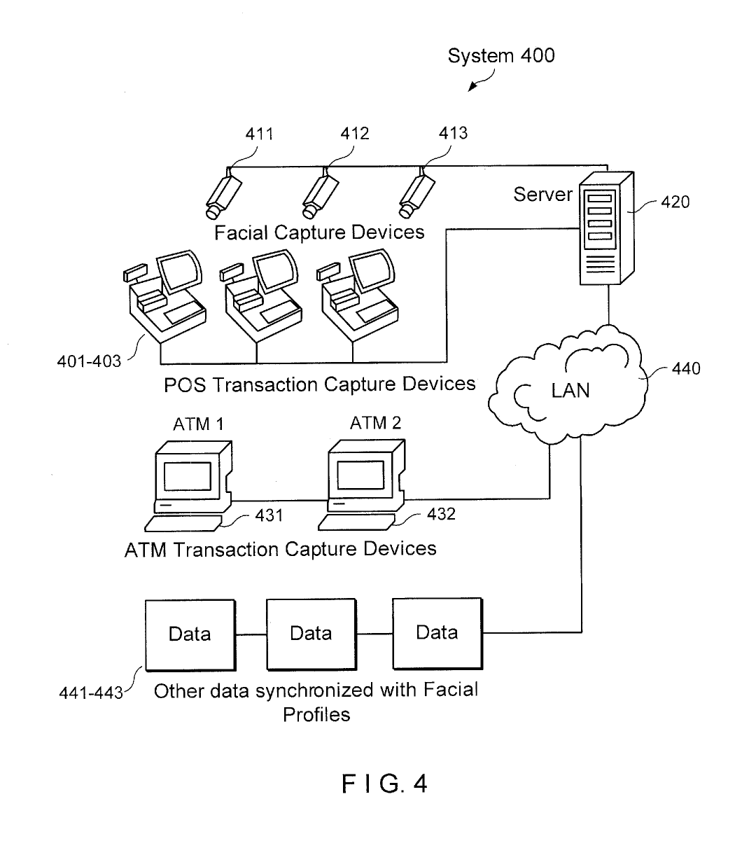

FIG. 4 shows an exemplary system 400 for implementing a facial recognition arrangement at a point-of-sale (“POS”) location according to the exemplary embodiments of the present invention. The system 400 may include a plurality of POS transaction capture devices 401-403, ATM transaction capture devices 431-423, a plurality of cameras 411-413, a server 420, a network such as a local area network (“LAN”) 440, a plurality of any other devices 441-443 utilizing data synchronized with customer profiles. Accordingly, facial data capture and face search engine may be integrated with any POS systems for complete retail solution in order to prevent and deter shoplifting, inventory shrinkage, fraud, etc.

According to the exemplary embodiments, the system 400 may allow for the reduction of losses at retail locations, the use of false credit/debit cards, any fictitious return of products, etc.). The system 400 may enhanced the quality of service. Specifically, the system 400 may allow managers to control all information on employees' actions, to utilize the LAN 440 for immediate transmission of information in minutes, etc., without leaving an office.

All purchase may be registered with a registered date/time attachment to a video recording of both the employee and the customer. The system 400 allows for remote real-time control and management from any point of the world, as well as centralized control of POS network. The system 400 may proved the managers with a powerful analysis toolset, including basic and extended requests, search of specified events, as well as statistics of a certain product's sales, minimum and maximum sum of purchases at every cash register, analysis of every POS operator work, etc. Furthermore, POS face integrated system 400 may work with both facial capture and face search engine products in order to provide a full turnkey solution for retail operation security and management.

Furthermore, entrance logs may be viewed from a remote location and, thus may be administrated by a manager remotely. In addition, all functions such as data modification, camera calibration, adjustment by size of the object, pan/tilt/zoom (“PTZ”) movement, system deactivation/activation may be controlled remotely, over network (e.g., LAN 440).

As noted above, gallery face may allow for multiple faces to be analyzed simultaneously. Accordingly, gallery faces may be an ideal solution for property management, gated communities, commercial buildings, places of employment, banks, airports, etc. The system may be capable of detecting background changes, motion detections, etc. For instance, frames may be customized frames based on location (e.g., entrance only frame). Therefore, the system may detect all access attempt, either authorize or unauthorized and will keep it in event log, such as within the database 115.

Using networked facial recognition, a centralized face monitoring station may captured faces and export files (e.g., JPG, AVI, etc.) and send via E-mail. Thus, a gallery of faces may be delivered to personnel, such as security guards or management, via smart phones for facial recognition analysis. The gallery of faces may be stored locally or may be backed-up to a central location on time bases, schedule bases or any other scenarios. Accordingly, images may be exported to hard disk, send via E-mails, SMS, printed out, etc.

According to the exemplary systems and method described herein, a face search engine may be a complete solution working with facial capture module. The system 100 may allow users to design and build a custom-made database of faces to match, compare, or integrated with other systems (e.g., third-party systems). The face search engine may be used to protect a facility and/or to maintain face access control security. Furthermore, the system 100 may also be used for VIP hospitality market (e.g., “Face Concierge”). For example, a user may build a database of employees, a database for security features, a database for a list of VIP quests, (e.g., “high rollers”), etc.

Face Concierge may allow the face search engine to be used not only from security point of view, but it may also be used also to greet people in a hospitality environment (e.g., a casino, a country club, a nightclub, etc.) For instance, a person walking into hotel lobby may allow for the front desk or concierge to have a profile on that person. This profile may include information such as, which room you like, smoking or non-smoking, what view is preferable, what kind of food your prefer, which food and beverage items are preferred, etc. Accordingly, this information may be passed through all hotel network environments, from the front desk, to the concierge, to the spa, to the fitness club, to the hotel stores, etc. For a multi-hotel chain, the information included in the customer profile may be transmitted to each location. In addition, Face Concierge may be integrated with access control, elevators control, HVIC systems, light control, POS, ATM, etc., in order to build a new generation of hospitality by implementing face capture and facial recognition technology.

Face Monitoring Station may combine both technology of Face Capture at local places, and transmit data over to centralized database for comparison in order to generate a notification (e.g., alerts, voice notification, E-mail message). This notification may attach an image of the person or small video file; may send image or small video clip to your mobile smart phone; may call designated number or multiple numbers, etc. Thus, Face Monitoring Station provides corporate, government, military, hospitality industries the ability to build and maintain proprietary databases, databases of watch list or unwanted individual, suspicious personnel, as well as creating a profile of VIP quests, preferred members, etc. Information in this proprietary databases may be secured from unauthorized access, and communication between local servers or local face capture stations may be highly secured.

Accordingly to the exemplary systems described herein, a Face Access Control system may be especially designed for access control of the entrance of a secured location. For instances, at the access point, the face of every person may be captured by a video camera using a face capture module (e.g., a facial recognition arrangement). The facial images may then be extracted and compared with the stored faces (e.g., of database 115) for facial recognition face search engine. If the captured face matches a stored face, access is permitted. For high security areas (e.g., drug storage, banks, military applications, etc.), the face search engine may be combined with other access control systems, such as card terminals, so that each card may only be used by its owner. Face Access Control may be networked together. Accordingly faces may be stored in the centralized station or database and then distributed automatically to all terminals. This centralized station or database may be simply multiplied in a network or the Internet in order to provide complex custom design for monitoring/control and multi-layer accesses to the system environment.

ATM Face Integrated Engine may be a fully integrated system with Face Capture and Face Search Engine. Specifically, ATM Face Integrated Engine may be described as a centralized video control system that provides 24 hours a day, 7 days a week security for cash machines is. All events taking place within the operation hours of an ATM may be recorded and stored in the database. The system may be design to reduce losses caused by fraud and vandalism. A central monitoring station may provide monitoring of all ATM machines within a network. Operators may view on their monitor areas near the ATM machine, as well as cash receiving zone and layouts of the guarded ATM. The ATM Face Integrated Engine system may allow for search capabilities by card number, by date and time, by event, etc. Since the system is integrated with Face Capture and Face Search Engine face image information may be attached to a particular credit/debit card for verification purpose or any alarm notifications.

According to the exemplary embodiments of the systems and methods described herein, property management and gated community may use face capture to improve services and security. Specifically, face captures systems may store images of all people entering the facility or building. Furthermore, this service may be extended to face search engine for facial recognition.

A common problem with Databases of facial images is that the same person may have duplicate entries with different photos of the same face and under different names. Images from different sources can be very quickly compared to the images stored in the database, resulting in a match list of the most similar faces. Beyond the high inspection through-put of the software that runs on standard hardware, the face recognition quality is key. The inspection and matching results may adapt to accommodate a user's growing requirements while reducing the operational cost to a minimum.

According to one embodiment, the exemplary facial capture and facial recognition modules may be separated. Accordingly, the system 100 may be highly scalable, capturing faces at local cameras and locations in real-time (or near real-time). In other words, an administrator of the system 100 does not need to change an existing security environment or add any additional cameras. The facial data may also be collected and managed directly by the administrator, or alternatively, outsourced to an external security station or lab for management.

As noted above, the exemplary systems and methods may use Delta Wavelet compression. Accordingly, data may be transmitted via low bandwidth capacity lines, get compared face in database and formalize event based on matched faces (e.g., send E-Mail, SMS message, send picture, small video, close doors, close elevators, turn on/off light, etc.) almost in “real time.

The exemplary database 115 may allow for any search capabilities, such as search by date, time, type, etc. Furthermore, the administrator may simultaneously record and monitor multiple locations in real-time. The system 100 may include various built-in security detectors, such as detecting a deactivated camera (e.g., somebody cut the wire to the camera), an obscured or covered camera (e.g., somebody cover camera with gum or paper), item recognition detection, (e.g., detecting a missing object in a frame), etc. The system 100 may also be integrated with facial access control, fire alarms, SKADA (e.g., for smart intelligent buildings applications), etc.

According to one exemplary embodiment of the present invention, an interactive installation provides an animated image (or “Face Avatar”) for interacting with a user. For example, the Face Avatar may be used with facial recognition profiling in applications such as, pay-per-click, pay-per-action, pay-per-lead, etc. This innovative software may bring facial recognition to life by simulating an active emotional and physical communication between the observer and a virtual personage. For instance, a female Avatar may be a stylized creation of a woman's face. From a distance, the observer sees a silhouette of an enigmatic woman's face, whose eyes, ears, hair and mouth are randomly animated to give the sensation of an interactive living being. Proximity sensors, microphone, camera, touch screen, etc. may facilitate interaction with the application. The installation may be framed like a painting, and may hide a computer behind the LCD screen. As the person approaches, the sensors may trigger an event at the monitoring station and interaction may begin. The face may advance towards the individual as in a mirror. If the user leans to the right or the left, the enigmatic eyes will follow. If the operator speaks, the avatar's mouth will move in the apparent intention to murmur. If the person touches the image on the screen, the mouth, eyes and eyelashes will react to this contact.

With multiple modules this interactive installation may change the way people interact in all spheres of life. For instance, “Face Avatar Concierge” may be designed to provide an interactive interface at reception desks. Specifically, this software may welcome guests at hotels, clubs, casinos, etc. While connected to a remote back office via an LCD screen and video camera, microphone, the facial capture and recognition technology may identify and log in the guest, as well as create or update their personalized profile. Based on the facial recognition, remote operators will access client profiles and serve each guest accordingly. This may thus provide a tool for reducing guest wait times and increasing efficiency. Face Avatar Concierge may be instrumental in creating a personalized experience that will be unique.

“Face Avatar Guard” may be designed to provide a virtual security guard. Specifically, this software may be designed to screen personnel and visitors. Comprising of a LCD screen and video camera, Face Avatar Guard may be connected to a Central Monitoring Station via the Internet. For instance, whenever someone approaches the LCD screen, a motion detector may trigger a reaction at a Central Monitoring Station. In order to determine the nature of the visit, a remote operator may engage the visiting individual in an interactive conversation. During the course of this interaction, the operator may capture facial features, create a profile and determine whether to allow or deny access.

“Face Avatar Retailer” may be designed for the retail industry to provide an interactive software program for shopping. With its LCD screen and video installed on the retail floor, cashier desk or merchandise return desk, this software may be used to integrate with club or loyalty cards, among other retail activities. Using facial recognition technology, the Face Avatar Retailer may create profiles of customers. Based on the customer profile, retailers will now be able to increase their sales by pre-emptying needs.

“Face Avatar Social Net”, similar to the Internet cookies technology, may be designed especially for the social networking sites. With its facial capturing and recognition component, Face Avatar Social Net may primarily collect information about the user. The software may store facial images with associated user profiles in the database. Information collected may then be linked to existing or new social networking sites. Based on the user requests with additional levels of drill-down profile related options, the system will create “looks like” searchable communities.

“Face Avatar Target Ad” (e.g., Pay Per Call, Pay Per Lead, Pay Per Question) may be described as software collecting general profiling information. For instance, Face Avatar Target Ad may be designed specifically for targeted advertising. Based on the client's needs, this software may ask survey questions related to specific products or services using custom predefined pay per click, pay per question, pay per click. Accordingly, the data collected may attach the customer profile and store the information in a user database. In addition to profiling and matching a target audience, this application may also generate new leads for the advertisement agencies, as well as targeted leads for business.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

It is claimed:

1. A method, comprising:
acquiring facial recognition data (“FRD”) related to a customer;
processing the FRD to generate a facial data identification (“FDI”);
analyzing a database including a plurality of customer profiles to match the FDI with a stored FRD corresponding to a customer, each customer profile including one of customer-specific keywords and customer-specific content;
when the FDI is unmatched, creating a new customer profile including the FRD and matching the new customer profile with a commercial application; and
when the FDI is matched with an existing customer profile, updating the existing customer profile and performing a service associated with the one of customer-specific keywords and customer-specific content stored in the matched customer profile.

2. The method of claim 1, further comprising:
when the FDI is unmatched, storing one of new customer-specific keywords and new customer-specific content in the new customer profile, and storing the new customer profile in the database.

3. The method of claim 1, wherein the one commercial application is based on integrated information received from one of a services database, a transaction database, a banking database, and a transportation database.

4. The method of claim 1, wherein the FRD is acquired from a facial recognition arrangement.

5. The method of claim 1, wherein the processing the FRD includes:
vectoring the facial data;
compressing the facial data; and
transferring the compressed facial data to a processing unit.

6. The method of claim 1, further comprising:
creating an avatar based on the existing customer profile for communication applications.

7. The method of claim 6, wherein the avatar is used in one of a pay-per-click application, a pay-per-action application, and a pay-per-lead application.

8. A system, comprising:
a facial recognition arrangement acquiring facial recognition data (“FRD”) related to a customer; and
a server processing the FRD to generate a facial data identification (“FDI”), the server analyzing a database including a plurality of customer profiles to match the FDI with a stored FRD corresponding to a customer, each customer profile including one of customer-specific keywords and customer-specific content;
when the FDI is unmatched, the server creates a new customer profile including the FRD and matches the new customer profile with a commercial application; and
when the FDI is matched with an existing customer profile, the server updates the existing customer profile and performs a service associated with the one of customer-specific keywords and customer-specific content stored in the matched customer profile.

9. The system of claim 8, further comprising:
when the FDI is unmatched, the server stores one of new customer-specific keywords and new customer-specific content in the new customer profile, and storing the new customer profile in the database.

10. The system of claim 8, wherein the one commercial application is based on integrated information received from one of a services database, a transaction database, a banking database, and a transportation database.

11. The system of claim 8, wherein the processing the FRD includes:
vectoring the facial data;
compressing the facial data; and
transferring the compressed facial data to a processing unit.

12. The system of claim 8, further comprising:
an avatar generating arrangement creating an avatar based on the existing customer profile for communication applications.

13. The system of claim 12, wherein the avatar is used in one of a pay-per-click application, a pay-per-action application, and a pay-per-lead application.

14. A computer readable storage medium including a set of instructions that are executable by a processor, the set of instructions being operable to:
acquire facial recognition data (“FRD”) related to a customer;
process the FRD to generate a facial data identification (“FDI”);
analyze a database including a plurality of customer profiles to match the FDI with a stored FRD corresponding to a customer, each customer profile including one of customer-specific keywords and customer-specific content;
when the FDI is unmatched, create a new customer profile including the FRD and match the new customer profile with a commercial application; and
when the FDI is matched with an existing customer profile, update the existing customer profile and perform a service associated with the one of customer-specific keywords and customer-specific content stored in the matched customer profile.

15. The computer readable storage medium of claim 14, wherein, when the FDI is unmatched, the set of instructions are further operable to:
store one of new customer-specific keywords and new customer-specific content in the new customer profile; and
store the new customer profile in the database.

16. The computer readable storage medium of claim 14, wherein the one commercial application is based on integrated information received from one of a services database, a transaction database, a banking database, and a transportation database.

17. The computer readable storage medium of claim 14, wherein the FRD is acquired from a facial recognition arrangement.

18. The computer readable storage medium of claim 14, wherein the processing the FRD includes:
vectoring the facial data;
compressing the facial data; and
transferring the compressed facial data to a processing unit.

19. The computer readable storage medium of claim 14, wherein the set of instructions are further operable to:
create an avatar based on the existing customer profile for communication applications.

20. The computer readable storage medium of claim 19, wherein the avatar is used in one of a pay-per-click application, a pay-per-action application, and a pay-per-lead application.
